(19) United States
(12) Patent Application Publication
(10) Pub. No.: US 2014/0340603 A1
(43) Pub. Date: Nov. 20, 2014

(54) PIXEL ARRAY SUBSTRATE

(71) Applicant: HannStar Display Corp., New Taipei City (TW)

(72) Inventors: Hsien-Tang Hu, Taichung City (TW); Da-Ching Tang, Tainan City (TW); Ko-Ruey Jen, Taipei City (TW); Jui-Chi Lai, Kaohsiung City (TW)

(21) Appl. No.: 13/939,195

(22) Filed: Jul. 11, 2013

(30) Foreign Application Priority Data
May 16, 2013 (CN) 201310181770.6

(51) Int. Cl. G02F 1/1343

(52) U.S. Cl. CPC G02F 1/134336
USPC 349/43

(57) ABSTRACT

A pixel array substrate includes a substrate, a plurality of thin-film transistors disposed on the substrate, a first insulating layer covering the thin-film transistors and the substrate, a common electrode disposed on the first insulating layer, a second insulating layer covering the first insulating layer and the common electrode, and a plurality of pixel electrodes disposed on the second insulating layer. Each thin-film transistor includes a drain electrode. The first insulating layer includes a plurality of first openings exposing the drain electrodes respectively. The second insulating layer includes a plurality of second openings exposing the first openings respectively. Each pixel electrode is electrically connected to each drain electrode respectively through each first opening and each second opening. The first insulating layer includes a thickness between 1 micron and 5 microns.

### BACKGROUND OF THE INVENTION

1. Field of the Invention

The present invention relates to a pixel array substrate, and more particularly, to a pixel array substrate with an increased aperture ratio.

2. Description of the Prior Art

Liquid crystal display panels have been applied to portable products, such as notebook, PDA, etc. because of having the advantages of light weight, thin thickness, low power consumption and no radiation pollution, and thus, the liquid crystal display panels have been gradually replaced the cathode ray tube (CRT) screen of the laptop computer.

Conventional liquid crystal display panel is formed with the color filter substrate, the pixel array substrate and the liquid crystal layer, in which the liquid crystal layer is disposed between the color filter substrate and the pixel array substrate, and directions of the liquid crystal molecules in the liquid crystal layer can be rotated to control the pixel to display brightness or darkness. Please refer to FIG. 1, which is a schematic diagram illustrating a cross-sectional view of a pixel array substrate according to the prior art. As shown in FIG. 1, the pixel array substrate 10 includes a substrate 12, thin-film transistors 14, a common line 16, a passivation layer 18, a planarization layer 20, and pixel electrodes 22. The thin-film transistors 14 are disposed on the substrate 12, and each thin-film transistor 14 includes a gate electrode 14a, a source electrode 14b, a drain electrode 14c, and a channel layer 14d. The common line 16 is disposed on the substrate 12. The passivation layer 18 covers the thin-film transistors 14 and the substrate 12, and has openings 18a exposing the drain electrodes 14c respectively. The planarization layer 20 covers the passivation layer 18, and has openings 20a respectively corresponding to the openings 18a and exposing the drain electrodes 14c. The pixel electrodes 22 are disposed on the planarization layer 20 and electrically connected to the drain electrodes 14c respectively through the openings 18a, 20a. Furthermore, the pixel electrodes 22 overlap the common line 16, so that the common line 16, the passivation layer 18, the planarization layer 20, and each pixel electrode 22 form a storage capacitor.

However, the common line 16 of the conventional pixel array substrate 10 is formed with a metal material, so that the common line 16 shields a part of pixel electrode 22, thereby affecting an aperture ratio of a pixel. Also, when the pixel electrodes 22 are disposed close to the thin-film transistors 14, the data lines or the scan lines, a capacitive coupling effect will be generated between the pixel electrodes 22 and the thin-film transistors 14, the data line or the scan lines, and affecting the display of the image. Also, the aperture ratio of the pixel array substrate 10 is accordingly limited.

Therefore, with the increase of the image resolution of the pixel array substrate, to raise the aperture ratio of the pixel structure is an objective in this field.

### SUMMARY OF THE INVENTION

It is one of the objectives of the present invention to provide a pixel array substrate to increase the aperture ratio of the pixel array substrate.

According to an aspect of the present invention, a pixel array substrate is provided. The pixel array substrate includes a substrate, a plurality of thin-film transistors, a first insulating layer, a common electrode, a second insulating layer, and a plurality of pixel electrodes. The thin-film transistors are disposed on the substrate, and each thin-film transistor includes a drain electrode. The first insulating layer covers the thin-film transistors and the substrate, and the first insulating layer includes a plurality of first openings exposing the drain electrodes respectively. The common electrode is disposed on the first insulating layer. The second insulating layer covers the first insulating layer and the common electrode, and the second insulating layer includes a plurality of second openings exposing the first openings respectively. The pixel electrodes are disposed on the second insulating layer, and each pixel electrode is electrically connected to each drain electrode respectively through each first opening and each second opening. The first insulating layer includes a thickness between 1 micron and 5 microns.

The first common electrode of the present invention is disposed between the pixel electrodes and the thin-film transistors, the scan lines and the data lines to shield the capacitive coupling effect between the pixel electrodes and the thin-film transistors, between the pixel electrodes and the scan lines and between the pixel electrodes and the data lines, so that the distance between at least one of each thin-film transistor, each data line and each scan line and each pixel electrode in the direction in parallel to the substrate can be shortened, and the aperture ratio can be raised.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-sectional view of a pixel array substrate according to the prior art.

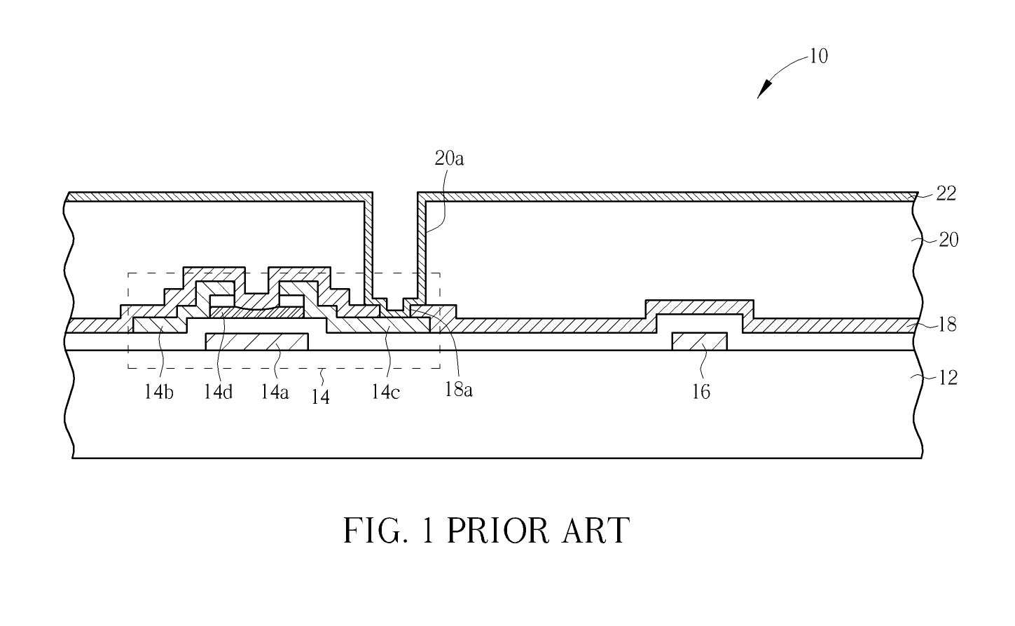

FIG. 2 is a schematic diagram illustrating a top view of a pixel array substrate according to an embodiment of the present invention.

FIG. 3 is a schematic diagram illustrating a cross-sectional view of FIG. 2 taken along with cross-sectional line A-A′.

FIG. 4 is a schematic diagram illustrating a cross-sectional view of a liquid crystal display panel according to an embodiment of the present invention.

### DETAILED DESCRIPTION

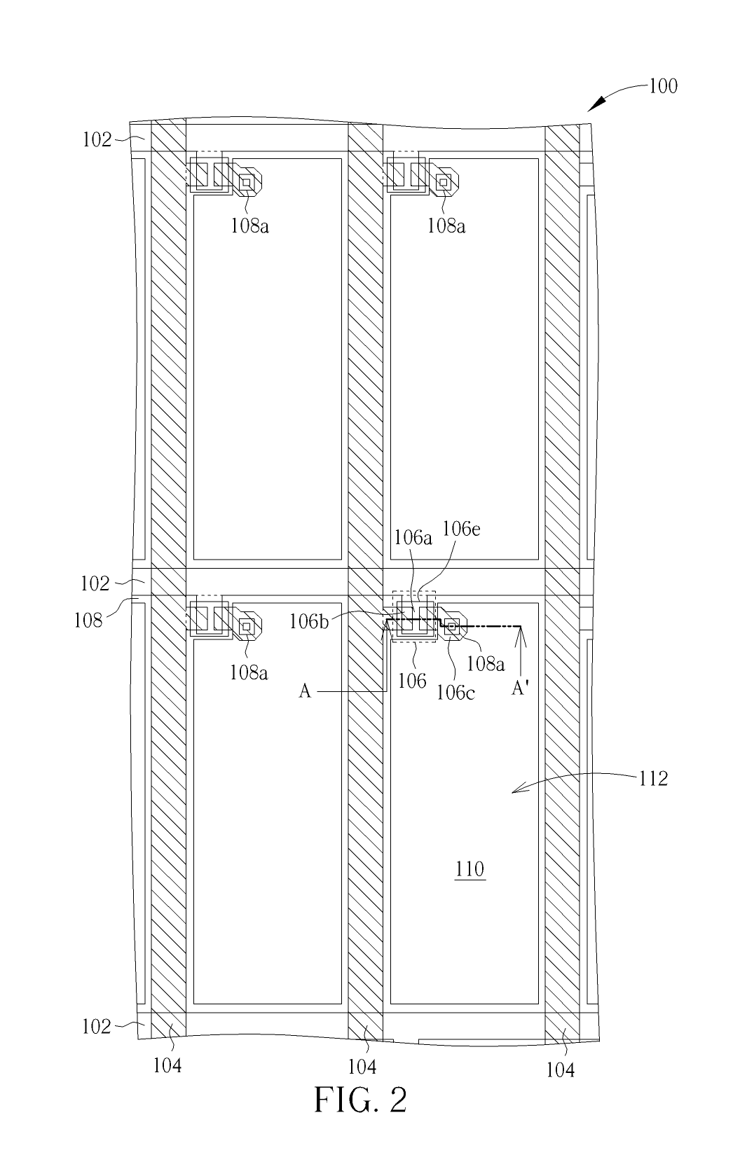

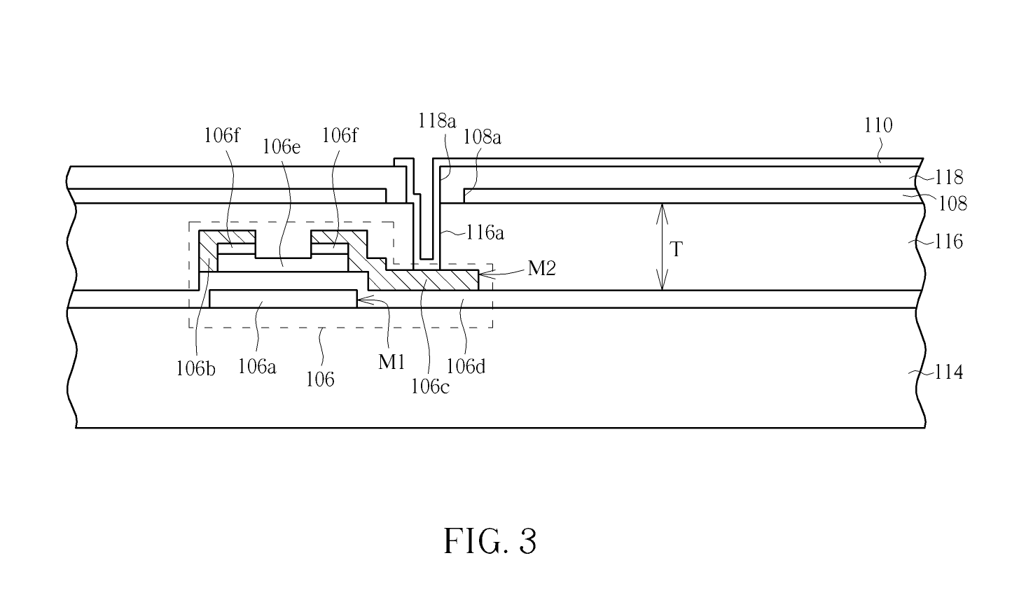

Please refer to FIGS. 2 and 3. FIG. 2 is a schematic diagram illustrating a top view of a pixel array substrate according to an embodiment of the present invention, and FIG. 3 is a schematic diagram illustrating a cross-sectional view of FIG. 2 taken along with cross-sectional line A-A′. As shown in FIG. 2, the pixel array substrate 100 includes a plurality of scan lines 102, a plurality of data lines 104, a plurality of thin-film transistors 106, a first common electrode 108, and a plurality of pixel electrodes 110. The data lines 104 cross the scan lines 102, and any two of the data lines 104 adjacent to each other and any two of the scan lines 102 adjacent to each other define a pixel region 112. The pixel regions 112 are arranged as a matrix. Each thin-film transistor 106 is disposed corresponding to each pixel region 112, and each thin-film transistor 106 includes a gate electrode 106a, a source electrode 106b, and a drain electrode 106c. Each gate electrode 106a is electrically connected to the corresponding scan line 102, and each source electrode 106b is electrically connected to the corresponding data line 104. In this embodiment, the gate electrodes 106a in the same row are extended from the same scan line 102 so as to be electrically connected to the same scan line 102. The gate electrodes 106a in different rows respectively are electrically connected to different scan lines 102. The source electrodes 106b in the same column are extended from the same data line 104 so as to be electrically connected to the same scan line 104. The source electrodes 106b in different columns respectively are electrically connected to different data lines 104. The present invention is not limited herein.

Additionally, the first common electrode 108 may overlap the thin-film transistors 106, the data lines 104 or the scan lines 102 to shield a capacitive coupling effect generated between the thin-film transistors 106, the data lines 104 or the scan lines 102 and an electrode or a wire disposed on the first common electrode 108. Accordingly, a distance between the thin-film transistors 106, the data lines 104 or the scan lines 102 and an electrode or a wire disposed on the first common electrode 108 in a direction in parallel to a first substrate 114 may be reduced.

In this embodiment, the first common electrode 108 overlaps the thin-film transistors 106, the data lines 104 and the scan lines 102 together, but the present invention is not limited to this. In a modified embodiment of the present invention, the first common electrode may only overlap the thin-film transistors, the data lines or the scan lines, or overlap any two of the thin-film transistors, the data lines and the scan lines. In addition, each pixel electrode 110 is disposed in each pixel region 112, and is electrically connected to each drain electrode 106c of each thin-film transistor 106. Also, each pixel electrode 110 is electrically insulated from the first common electrode 108.

For detailing the pixel array substrate 100 of this embodiment, a structure in a single pixel region 112 is taken as an example in the following description, but the present invention is not limited to this. As shown in FIGS. 2 and 3, the pixel array substrate 100 may further include a first substrate 114, a first insulating layer 116, and a second insulating layer 118. Each gate electrode 106a is disposed on the first substrate 114 and formed by patterning a first metal layer Ml. In this embodiment, each scan line 102 may be formed with the same first metal layer Ml as each gate electrode 106a and disposed on the first substrate 114, but the present invention is not limited herein. Furthermore, each thin-film transistor 106 is disposed on the first substrate 114, and further includes a gate insulating layer 106d, a channel layer 106e and an ohmic contact layer 106f. The gate insulating layer 106d covers each gate electrode 106a and the first substrate 114 and formed with an insulating material, such as silicon nitride, silicon oxide, silicon oxynitride, other suitable dielectric material or a combination thereof, but the present invention is not limited herein. Each channel layer 106e is disposed on the gate insulating layer 106d and disposed right on each gate electrode 106a. Each channel layer 106e may include, such as amorphous silicon, polysilicon, metal oxide semiconductor material or other semiconductor material, but the present invention is not limited herein. Each ohmic contact layer 106f is disposed between each channel layer 106e and each source electrode 106b and between each channel layer 106e and each drain electrode 106c, and used for reducing a contact resistance between silicon and metal material. Each ohmic contact layer 106f may include, such as amorphous silicon, polysilicon, metal oxide semiconductor material doped with ions or other semiconductor material, but the present invention is not limited herein. Furthermore, each source electrode 106b and each drain electrode 106c are disposed on each channel layer 106e and the gate insulating layer 106d and partially overlap each gate electrode 106a. In this embodiment, each source electrode 106b, each drain electrode 106c and each data line 104 may be formed by patterning a second metal layer M2, but the present invention is not limited to this. Each thin-film transistor, each scan line and each data line of the present invention are not limited the above-mentioned structure and may be other variants. For example, the thin-film transistor may be other kinds of transistors according to different driving methods or requirements. Any two of the adjacent scan lines and any two of the adjacent data lines may surround not only one pixel region.

In addition, the first insulating layer 116 covers each thin-film transistor 106, each scan line 102, each data line 104, and the gate insulating layer 106d, and includes a plurality of first openings 116a exposing the drain electrodes 106c respectively. The first insulating layer 116 in this embodiment may include acrylic resin, a compound composed of silicon, oxide, carbon and hydrogen, a compound composed of silicon, oxide and carbon, or a compound composed of silicon and oxide, but is not limited to this. The compound composed of silicon, oxide, carbon and hydrogen may include siloxane compound. Since the first insulating layer 116 covers the whole first substrate 114, the first insulating layer 116 has a transmittance larger than 95% so as to avoid stopping the light passing through the pixel regions 112. The first insulating layer 116 may include a photosensitive material or a non-photosensitive material. When the first insulating layer 116 includes the photosensitive material, the first openings 116a may be directly formed in the first insulating layer 116 by performing an exposure process. Or, when the first insulating layer 116 includes the non-photosensitive material, the first openings 116a may be formed via a photo mask in the first insulating layer 116 by performing a photolithographic and etching process. Also, the first insulating layer 116 is formed to cover each thin-film transistor 106, each scan line 102, each data line 104 and the gate insulating layer 106d through performing a coating process, such as a spin-coating process or a slit coating process.

Furthermore, the first common electrode 108 is disposed on the first insulating layer 116, and includes a plurality of third openings 108a. Each third opening 108a is disposed corresponding to and larger than each first opening 116a, and exposes each first opening 116a, so that the first common electrode 108 does not extend into the first openings 116a, and is not electrically connected to each drain electrode 106c respectively exposed by each first opening 116a. The first common electrode 108 may be used for transferring a common signal. Also, the first common electrode 108 may be formed with a transparent conductive material, such as indium tin oxide, indium zinc oxide, aluminum tin oxide or aluminum zinc oxide, but the present invention is not limited to this.

In addition, the second insulating layer 118 covers the first insulating layer 116 and the first common electrode 108, and includes a plurality of second openings 118a. Each second opening 118a exposes each first opening 116a and each drain electrode 106c. The second insulating layer 118 may be formed with an inorganic material, such as silicon nitride. Since the step of forming the second insulating layer 118 should be performed under an environment of a temperature larger than 280 t , the first insulating layer 116 preferably includes the compound composed of silicon, oxide, carbon and hydrogen, the compound composed of silicon, oxide and carbon, or the compound composed of silicon and oxide because the compound composed of silicon, oxide, carbon and hydrogen, the compound composed of silicon, oxide and carbon, or the compound composed of silicon and oxide can tolerate a higher temperature than the temperature that acrylic resin can tolerate. Furthermore, the first insulating layer 116 includes a weight loss ratio smaller than 1% at 300° C., so that the characteristic and the structure of the first insulating layer 116 can be avoided being damaged during forming the second insulating layer 118.

Moreover, each pixel electrode 110 is disposed on the second insulating layer 118, and is electrically connected to each drain electrode 106c through each first opening 116a and each second opening 118a. In this embodiment, each pixel electrode 110 may for example extend into each first opening 116a and each second opening 118a to be in contact with each drain electrode 106c and electrically connected to each drain electrode 106c, but the present invention is not limited to this. The pixel electrodes 110 may be formed with a transparent conductive material, such as indium tin oxide, indium zinc oxide, aluminum tin oxide or aluminum zinc oxide, but the present invention is not limited to this.

It should be noted that each third opening 108a is larger than each second opening 118a in this embodiment, so that each second opening 118a does not expose first common electrode 108, and each pixel electrode 110 can be electrically insulated from the first common electrode 108 through the second insulating layer 118. Furthermore, the first insulating layer 116 includes a thickness T between 1 micron and 5 microns, and the first insulating layer 116 includes a dielectric constant between 2 farads per meter (F/m) and 5 F/m, so that the capacitive coupling effect between the first common electrode 108 and each thin-film transistor 106, the capacitive coupling effect between the first common electrode 108 and each scan line 102 and the capacitive coupling effect between the first common electrode 108 and each data line 104 can be reduced. Also, the first common electrode 108 may be disposed between at least one of each thin-film transistor 106, each data line 104 and each scan line 102 and each pixel electrode 110 to decrease the capacitive coupling effect between at least one of each thin-film transistor 106, each data line 104 and each scan line 102 and each pixel electrode 110. Accordingly, a distance between at least one of each thin-film transistor 106, each data line 104 and each scan line 102 and each pixel electrode 110 in the direction in parallel to the first substrate 114 can be shortened. Thus, each pixel electrode 110 may be increased effectively, and each pixel region 112 limited by each pixel electrode 110 also may be raised to increase the aperture ratio of the pixel array substrate 100 in this embodiment effectively. In various kinds of the liquid crystal display panel, the increased value of the aperture ratio may be different. As compared with the prior art, there is only the second insulating layer 118 disposed between each pixel electrode 110 and the first common electrode 108 in this embodiment, so that the capacitance of the storage capacitor formed with each pixel electrode 110, the second insulating layer 118 and the first common electrode 108 can be increased effectively, and the capacitance of the storage capacitor may be controlled by adjusting an overlapping area between each pixel electrode 110 and the first common electrode 108.

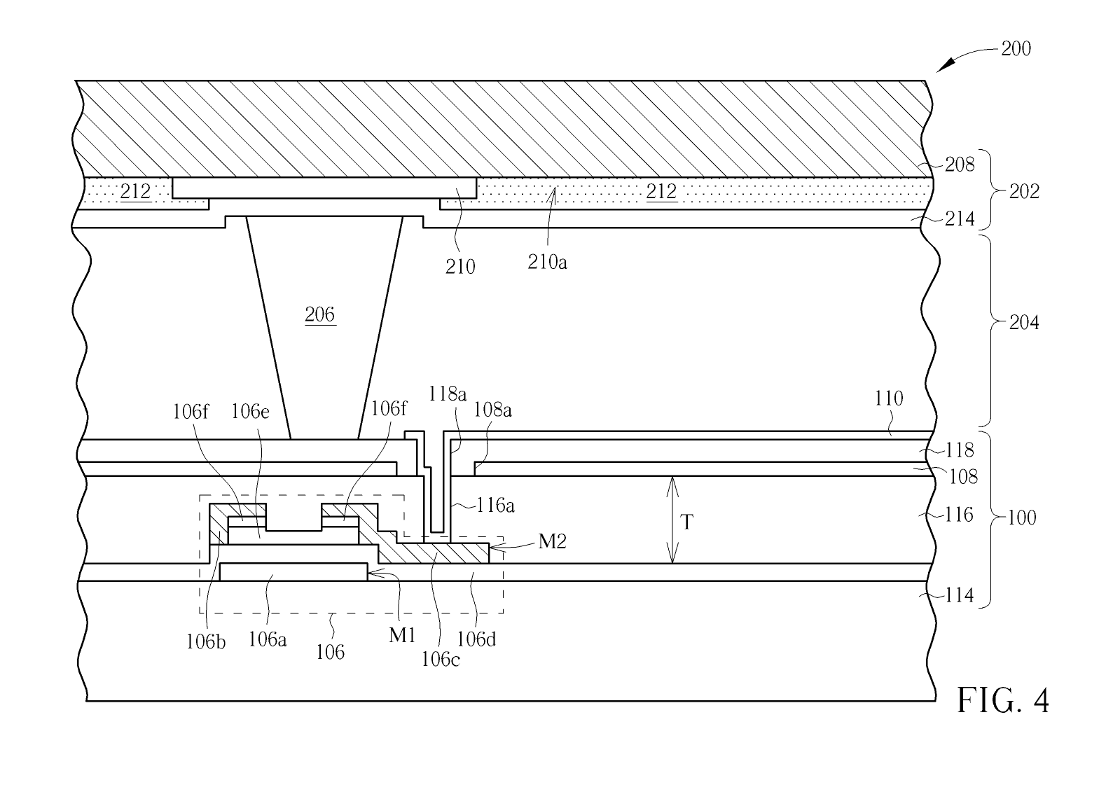

Please refer to FIG. 4, which is a schematic diagram illustrating a cross-sectional view of a liquid crystal display panel according to an embodiment of the present invention. As shown in FIG. 4, the liquid crystal display panel 200 includes the pixel array substrate 100, a color filter substrate 202, a liquid crystal layer 204, and a spacer 206. The color filter substrate and the pixel array substrate 100 are disposed opposite to each other, and the liquid crystal layer 204 is disposed between the color filter substrate 202 and the pixel array substrate 100. The spacer 206 is disposed between the color filter substrate 202 and the pixel array substrate 100 and used for sustaining a gap between the color filter substrate 202 and the pixel array substrate 100, and preferably disposed on the thin-film transistors 106. The color filter substrate 202 includes a second substrate 208, a black matrix layer 210, a color filter layer 212 and a second common electrode 214. The black matrix layer 210 is disposed on the second substrate 208, and includes a plurality of fourth openings 210a. Each fourth opening 210a is disposed corresponding to each pixel region 112 and exposes second substrate 208. The color filter layer 212 covers the second substrate 208 exposed with each fourth opening 210a, and includes a plurality of color filters, such as red color filters, green color filters, and blue color filters. The second common electrode 214 covers the color filter layer 212 and the black matrix layer 210, and is used for receiving the common signal. In other embodiments of the present invention, the first common electrode and the second common electrode may be used for receiving different voltage signals respectively. Or, the color filter substrate may not include the second common electrode, and each pixel electrode may be patterned to have slits, so that the liquid crystal display panel is an in-plane switching liquid crystal display panel. In another embodiment of the present invention, the pixel array substrate may be used as another active matrix display panel, such as organic electroluminescent display panel.

In summary, the first common electrode of the present invention is disposed between the pixel electrodes and the thin-film transistors, the scan lines and the data lines to shield the capacitive coupling effect between the pixel electrodes and the thin-film transistors, between the pixel electrodes and the scan lines and between the pixel electrodes and the data lines, so that the distance between at least one of each thin-film transistor, each data line and each scan line and each pixel electrode in the direction in parallel to the first substrate can be shortened, and the aperture ratio can be raised. Also, the first insulating layer may include the compound composed of silicon, oxide, carbon and hydrogen, the compound composed of silicon, oxide and carbon, or the compound composed of silicon and oxide so as to tolerate higher temperature. Accordingly, the characteristic and the structure of the first insulating layer can be avoided being damaged during forming the second insulating layer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pixel array substrate, comprising:
a substrate;
a plurality of thin-film transistors disposed on the substrate, and each thin-film transistor comprising a drain electrode;
a first insulating layer covering the thin-film transistors and the substrate, and the first insulating layer comprising a plurality of first openings exposing the drain electrodes respectively;
a common electrode disposed on the first insulating layer;
a second insulating layer covering the first insulating layer and the common electrode, and the second insulating layer comprising a plurality of second openings exposing the first openings respectively; and
a plurality of pixel electrodes disposed on the second insulating layer, and each pixel electrode electrically connected to each drain electrode respectively through each first opening and each second opening;
wherein the first insulating layer comprises a thickness between 1 micron and 5 microns.

2. The pixel array substrate according to claim 1, wherein the first insulating layer comprises a compound composed of silicon, oxide and carbon.

3. The pixel array substrate according to claim 1, wherein the first insulating layer comprises acrylic resin.

4. The pixel array substrate according to claim 1, wherein the first insulating layer comprises a dielectric constant between 2 farads per meter (F/m) and 5 F/m.

5. The pixel array substrate according to claim 1, wherein the first insulating layer comprises a weight loss ratio smaller than 1% at 300° C.

6. The pixel array substrate according to claim 1, wherein the common electrode comprises a plurality of third openings exposing the first openings respectively.

7. The pixel array substrate according to claim 6, wherein each third opening is larger than each second opening.

8. The pixel array substrate according to claim 1, wherein the common electrode is formed with a transparent conductive material.

9. The pixel array substrate according to claim 1, wherein the common electrode is formed with indium tin oxide, indium zinc oxide, aluminum tin oxide or aluminum zinc oxide.

10. The pixel array substrate according to claim 1, wherein the common electrode overlaps the thin-film transistors.

11. A pixel array substrate, comprising:
a substrate;
a plurality of thin-film transistors disposed on the substrate, and each thin-film transistor comprising a drain electrode;
a first insulating layer covering the thin-film transistors and the substrate, and the first insulating layer comprising a plurality of first openings exposing the drain electrodes respectively;
a common electrode disposed on the first insulating layer;
a second insulating layer covering the first insulating layer and the common electrode, and the second insulating layer comprising a plurality of second openings exposing the first openings respectively; and
a plurality of pixel electrodes disposed on the second insulating layer, and each pixel electrode electrically connected to each drain electrode respectively through each first opening and each second opening;
wherein the first insulating layer comprises a dielectric constant between 2 F/m and 5 F/m.

12. The pixel array substrate according to claim 11, wherein the common electrode comprises a plurality of third openings exposing the first openings respectively.

13. The pixel array substrate according to claim 12, wherein each third opening is larger than each second opening.

14. The pixel array substrate according to claim 11, wherein the common electrode is formed with a transparent conductive material.

15. The pixel array substrate according to claim 11, wherein the common electrode overlaps the thin-film transistors.

16. A pixel array substrate, comprising:
a substrate;
a plurality of thin-film transistors disposed on the substrate, and each thin-film transistor comprising a drain electrode;
a first insulating layer covering the thin-film transistors and the substrate, and the first insulating layer comprising a plurality of first openings exposing the drain electrodes respectively;
a common electrode disposed on the first insulating layer;
a second insulating layer covering the first insulating layer and the common electrode, and the second insulating layer comprising a plurality of second openings exposing the first openings respectively; and
a plurality of pixel electrodes disposed on the second insulating layer, and each pixel electrode electrically connected to each drain electrode respectively through each first opening and each second opening;
wherein the first insulating layer comprises a weight loss ratio smaller than 1% at 300° C.

17. The pixel array substrate according to claim 16, wherein the common electrode comprises a plurality of third openings exposing the first openings respectively.

18. The pixel array substrate according to claim 17, wherein each third opening is larger than each second opening.

19. The pixel array substrate according to claim 16, wherein the common electrode is formed with a transparent conductive material.

20. The pixel array substrate according to claim 16, wherein the common electrode overlaps the thin-film transistors.
